(19) United States
(12) Patent Application Publication
(10) Pub. No.: US 2026/0268572 A1
(43) Pub. Date: Sep. 10, 2026

(54) EFFECT IMAGE GENERATION METHOD AND APPARATUS, ELECTRONIC DEVICE, AND STORAGE MEDIUM

(71) Applicant: Beijing Zitiao Network Technology Co., Ltd., Beijing (CN)

(72) Inventor: Denggao Wang, Beijing (CN)

(21) Appl. No.: 18/873,647

(22) PCT Filed: Aug. 30, 2023
(86) PCT No.: PCT/CN2023/115650

§ 371 Date: Dec. 10, 2024

(30) Foreign Application Priority Data
Sep. 8, 2022 (CN) 202211098179.X

(51) Int. Cl. G06T 13/80; G06T 7/246

(52) U.S. Cl. CPC G06T 13/80; G06T 7/246

(57) ABSTRACT

Embodiments of the present disclosure provide an effect image generation method and apparatus, an electronic device, and a storage medium. The method comprises: acquiring an image to be processed in response to an effect trigger operation; determining an edge contour effect corresponding to the image to be processed; and adding the edge contour effect to the image to be processed to obtain a target effect image, where the edge contour effect is obtained based on a distance field and at least one noise image.

The present application claims priority to Chinese Patent Application No. 202211098179.X, filed with the China National Intellectual Property Administration on Sep. 8, 2022, which is incorporated herein by reference in its entirety.

### TECHNICAL FIELD

Embodiments of the present disclosure relate to image processing technologies, and for example, to an effect image generation method and apparatus, an electronic device, and a storage medium.

### BACKGROUND

With the development of network technologies, more and more applications have entered the lives of users. For example, a series of software for shooting short videos are deeply loved by users.

Software developers can add various effect props to applications for users to use during video shooting. However, the effect props provided to users are very limited, and the quality of videos and the richness of their content need to be further improved. For example, when an effect is added to an outline of an object in an image or an effect is added to a border of an image, the effect image generated based on the effect prop is poor.

### SUMMARY

The present disclosure provides an effect image generation method and apparatus, an electronic device, and a storage medium, to add an edge contour effect to an edge contour of an image to be processed, thereby improving the richness and interestingness of effect display images.

According to a first aspect, embodiments of the present disclosure provide an effect image generation method. The method includes:
acquiring an image to be processed in response to an effect trigger operation;
determining an edge contour effect corresponding to the image to be processed; and
obtaining a target effect image by adding the edge contour effect to the image to be processed,
where the edge contour effect is obtained based on a distance field and at least one noise image.

According to a second aspect, embodiments of the present disclosure further provide an effect image generation apparatus. The apparatus includes:
an image to be processed acquisition module configured to acquire an image to be processed in response to an effect trigger operation;
an edge contour effect determination module configured to determine an edge contour effect corresponding to the image to be processed; and
a target effect image determination module configured to obtain a target effect image by adding the edge contour effect to the image to be processed, where the edge contour effect is obtained based on a distance field and at least one noise image.

According to a third aspect, embodiments of the present disclosure further provide an electronic device. The electronic device includes:
one or more processors; and
a storage apparatus configured to store one or more programs, where
the one or more programs, when executed by the one or more processors, cause the one or more processors to implement the effect image generation method according to any of the embodiments of the present disclosure.

According to a fourth aspect, embodiments of the present disclosure further provide a storage medium including computer-executable instructions that, when executed by a computer processor, are configured to perform the effect image generation method according to any of the embodiments of the present disclosure.

### BRIEF DESCRIPTION OF THE DRAWINGS

Throughout the drawings, the same or similar reference numerals denote the same or similar elements. It should be understood that the drawings are schematic and that parts and elements are not necessarily drawn to scale.

FIG. 1 is a schematic flowchart of an effect image generation method according to embodiments of the present disclosure;

FIG. 2 is a schematic diagram of a distance field according to embodiments of the present disclosure;

FIG. 3 is a schematic diagram of a frame effect according to embodiments of the present disclosure;

FIG. 4 is a schematic diagram of a target effect image according to embodiments of the present disclosure;

FIG. 5 is a schematic flowchart of another effect image generation method according to embodiments of the present disclosure;

FIG. 6 is a schematic diagram of a disturbed distance field according to embodiments of the present disclosure;

FIG. 7 is a schematic diagram of fractal noise according to embodiments of the present disclosure;

FIG. 8 is a schematic diagram of superposition of a disturbed distance field and a noise image according to embodiments of the present disclosure;

FIG. 9 is a schematic diagram of noise to be applied according to embodiments of the present disclosure;

FIG. 10 is a schematic structural diagram of an effect image generation apparatus according to embodiments of the present disclosure; and

FIG. 11 is a schematic structural diagram of an electronic device according to embodiments of the present disclosure.

### DETAILED DESCRIPTION

The embodiments of the present disclosure will be described below with reference to the accompanying drawings. Although some embodiments of the present disclosure are shown in the accompanying drawings, it should be understood that the present disclosure may be implemented in various forms and should not be construed as being limited to the embodiments set forth herein. These embodiments are provided for a more thorough and complete understanding of the present disclosure. It should be understood that the accompanying drawings and the embodiments of the present disclosure are only for exemplary purposes, and are not intended to limit the scope of protection of the present disclosure.

A plurality of steps described in the method implementations of the present disclosure may be performed in different orders and/or performed in parallel. In addition, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

Concepts such as “first” and “second” mentioned in the present disclosure are only used to distinguish different apparatuses, modules, or units, and are not used to limit the sequence or interdependence of functions performed by these apparatuses, modules, or units.

Modifiers such as “one” and “a plurality of” mentioned in the present disclosure are illustrative and not restrictive, and those skilled in the art should understand that unless the context clearly indicates otherwise, the modifiers should be understood as “one or more”.

Names of messages or information exchanged between a plurality of apparatuses in the implementations of the present disclosure are used for illustrative purposes only, and are not used to limit the scope of these messages or information.

Before using the technical solution disclosed in the plurality of embodiments of the present disclosure, the user should be informed of, in an appropriate manner in accordance with relevant laws and regulations, the type, scope of use, use scenario, and the like of the personal information involved in the present disclosure and obtain the user's authorization.

For example, when receiving an active request from a user, a prompt message is sent to the user, to explicitly prompt the user that the operation requested by the user will need to obtain and use the user's personal information. Therefore, the user can independently choose whether to provide personal information to a software or hardware such as an electronic device, an application, a server, or a storage medium that executes an operation of the technical solution of the present disclosure, based on the prompt message.

As an optional but non-limiting implementation, for example, the manner of sending the prompt message to the user in response to receiving the active request from the user may be a pop-up window, and the prompt message may be presented in the pop-up window in text. In addition, the pop-up window may also carry a select control for the user to select “agree” or “disagree” to provide personal information to the electronic device.

The above notification and user authorization obtaining process is only schematic, and does not limit the implementation of the present disclosure. Other manners that meet relevant laws and regulations may also be applied to the implementation of the present disclosure.

The data involved in this technical solution (including but not limited to the data itself, the acquisition or use of the data) shall comply with the requirements of corresponding laws, regulations and related provisions.

Before the technical solution of the present disclosure is described, the application scenarios are first described by way of example. The technical solution of the embodiments of the present disclosure may be applied in any scenario in which an effect video needs to be generated. For example, when a user uploads a pre-acquired image to a server corresponding to an application, or acquires an image in real time through a mobile terminal including an imaging apparatus, a corresponding edge contour effect may be determined based on the technical solution of the embodiments of the present disclosure according to image content of an image to be processed, or an edge contour effect that is pre-developed and designed and selected by the user from effect props may be added to the image to be processed, so that a target effect image can be obtained.

FIG. 1 is a schematic flowchart of an effect image generation method according to embodiments of the present disclosure. The embodiments of the present disclosure are applicable to a case of processing an image to be processed to obtain a target effect image including an edge contour effect in any effect display or effect processing scenario supported by the Internet. The method may be performed by an effect image generation apparatus, which may be implemented in the form of software and/or hardware, and optionally, may be implemented by an electronic device, which may be a mobile terminal, a personal computer (PC), or a server.

As shown in FIG. 1, the method includes the following steps.

S110: Acquiring an image to be processed in response to an effect trigger operation.

An apparatus that executes the effect image generation method provided in the embodiments of the present disclosure may be integrated into an application software that supports an effect image processing function, and the software may be installed in an electronic device. Optionally, the electronic device may be a mobile terminal, a PC, or the like. The application software may be a type of software for image/video processing. Specific application software will not be enumerated here, as long as image/video processing can be implemented. The apparatus that executes the effect image generation method provided in the embodiments of the present disclosure may also be a specially developed application program for implementing adding and displaying an effect, or the apparatus that executes the effect image generation method provided in the embodiments of the present disclosure is integrated into a corresponding page, and a user may process an effect image through a page integrated in a PC.

In this embodiment, a control for triggering an effect may be pre-developed in an application software or application program that supports an effect video processing function. When it is detected that a user triggers the control, a response may be made to the effect trigger operation, thereby acquiring the image to be processed.

The image to be processed may be an image that needs to be processed. The image may be an image acquired based on a terminal device, or an image pre-stored by the application software in a storage space. The terminal device may refer to an electronic product with an image shooting function, such as a camera, a smart phone, and a tablet computer. In practical applications, when it is detected that the user triggers the effect trigger operation, the terminal device may be oriented toward the user to acquire the image to be processed. Alternatively, when it is detected that the user triggers the effect trigger operation, a plurality of images associated with the effect are determined in a specific database, and one or more of the plurality of images are determined as the image to be processed according to a preset screening rule.

In practical applications, the image to be processed is usually acquired when some effect operations are triggered. In this case, the effect trigger operation may include at least one of: triggering an effect prop; triggering an effect wake-up word by audio information; and a current body movement being consistent with a preset body movement.

In this embodiment, a control for triggering an effect prop may be preset. When the user triggers the control, an effect prop display page may pop up on a display interface, and a plurality of effect props may be displayed on the display page. The user may trigger a corresponding effect prop. When it is detected that the user triggers an effect prop corresponding to the acquisition of the image to be processed, it indicates that the effect trigger operation is triggered. Another implementation of triggering the effect trigger operation is as follows: audio information of the user may be pre-acquired, and the acquired audio information is analyzed and processed to recognize text corresponding to the audio information. If the text corresponding to the audio information includes a preset wake-up word, optionally, the wake-up word may be a word such as “please shoot the current image” or “please turn on the effect function”, it indicates that the effect trigger operation is triggered, and the image to be processed in the display interface may be acquired. Another implementation of triggering the effect trigger operation is as follows: some body movements may be preset as effect trigger movements. When it is detected that a body movement currently made by a user within a field of vision is consistent with the preset body movement, it may be determined that the effect trigger operation is triggered. Optionally, the preset body movement may be raising a hand, opening a mouth, turning a head, or the like.

S120: Determining an edge contour effect corresponding to the image to be processed.

The edge contour effect is obtained based on a distance field and at least one noise image.

In this embodiment, the edge contour effect may be an effect displayed at an edge of any border in the image to be processed or an outline of an object included in the image to be processed. For example, the edge contour effect may be a flame effect, that is, a flame effect is displayed at an edge of any border in the image to be processed or an outline of an object included in the image to be processed. The edge contour effect may be a static effect or a dynamic effect.

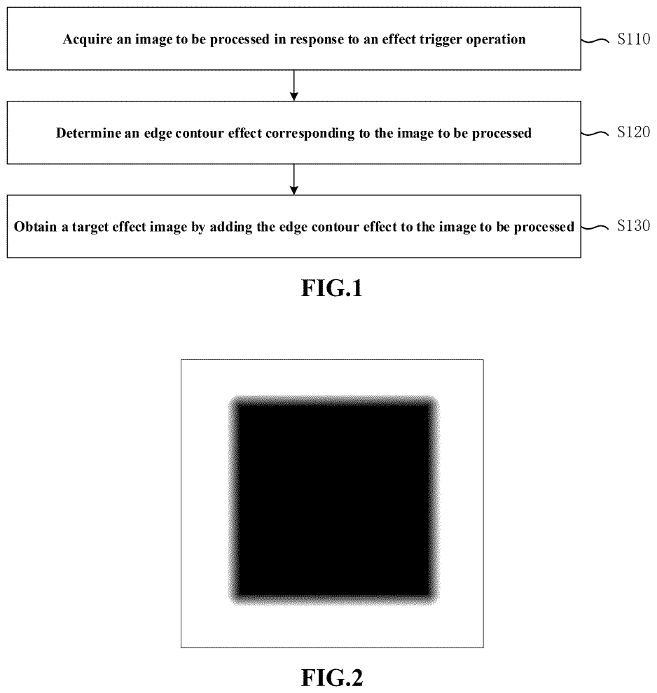

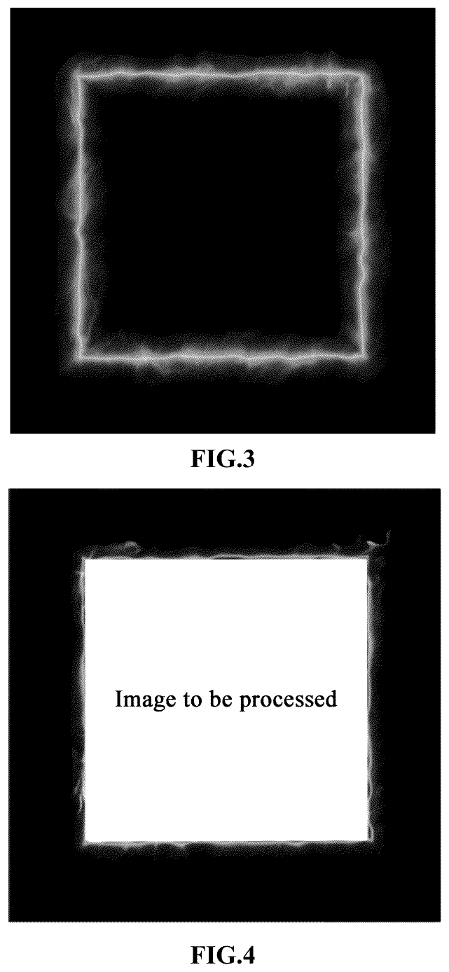

A person skilled in the art may understand that the distance field may be a signed distance field, and may represent that when coordinates of a point in a transfer space are returned, a shortest distance between the point and a surface is returned, and a sign of a returned distance value may represent whether the point is inside or outside the surface. For example, as shown in FIG. 2, a border may be preset. A distance value between each pixel point in an inner region of the border and the border may be set to a negative value, which may be represented in black. A distance value between each pixel point in an outer region of the border and the border may be set to a positive value, which may be represented in white. A distance value within a specific range inside and outside the border may be obtained. For example, a region from −0.5 to 1 may be obtained, and the region may be used as the distance field, that is, a junction between a white region and a black region in FIG. 2. The noise image may be an image generated based on a noise principle. Optionally, the noise image may include a noise image generated based on a value noise principle and a noise image generated based on a fractal noise principle.

In practical applications, the distance field corresponding to the image to be processed may be first determined, and then at least one noise image is determined, so that the edge contour effect corresponding to the image to be processed may be determined based on the distance field and the at least one noise image.

The image to be processed may include one or more objects, or may not include any object. When the image to be processed includes an object, the edge contour effect corresponding to the image to be processed may be determined based on the object. When the image to be processed does not include an object, the edge contour effect corresponding to the image to be processed may be determined arbitrarily.

Optionally, the edge contour effect includes an object contour effect corresponding to a target subject in the image to be processed and/or a frame effect corresponding to the image to be processed.

In this embodiment, the target subject may be a subject in the image to be processed to which an edge contour effect needs to be added. The image to be processed may include one or more subjects. After the image to be processed is obtained, the subject to which the edge contour effect needs to be added may be determined based on a user's selection, and the subject may be used as the target subject. In this case, the edge contour effect added to the target subject may be the object contour effect. The target subject may be any object, such as an animal or a person. The number of target subjects may be one or more. For example, when the target subject is an animal, the object contour effect may be an effect added to an outer edge line of the animal.

In this embodiment, the frame effect may be an effect of any border shape. Optionally, the frame effect may include a square frame effect, a circular frame effect, a heart-shaped frame effect, a polygon frame effect, and the like. For example, as shown in FIG. 3, a square border in FIG. 3 is a schematic diagram of an effect of the square frame effect. The advantage of this setting is that the effect display props are enriched, and the richness and interestingness of the picture content are improved.

Since there may be a target subject in the image to be processed that needs to be effect rendered, when determining the edge contour effect corresponding to the image to be processed, it is also possible to first determine whether the image to be processed includes the target subject.

Optionally, the determining an edge contour effect corresponding to the image to be processed includes: determining whether the image to be processed includes a target subject; and if the image to be processed includes the target subject, generating an object contour effect based on the target subject; or if the image to be processed does not include the target subject, generating a frame effect based on the image to be processed.

In practical applications, the target subject in the image may be pre-labeled, and the labeled image may be uploaded to a server, so that the server can store a feature attribute of the target subject. After the image to be processed is acquired, it may be determined whether the image to be processed includes the target subject by detecting whether the image to be processed includes the feature attribute of the target subject. When it is detected that the image to be processed includes the feature attribute of the target subject, the subject in the current image may be determined as the target subject, and then an edge line contour of the target subject may be determined, so that a corresponding object contour effect may be generated based on the edge line contour of the target subject. If the feature attribute of the target subject is not detected in the image to be processed, a frame effect corresponding to the image to be processed may be determined. The advantage of this setting is that the form of effect display and the display effect of the effect image are enriched, and the diversity of the effect image processing solution is enhanced.

S130: Obtaining a target effect image by adding the edge contour effect to the image to be processed.

In this embodiment, after the edge contour effect is determined, the edge contour effect may be added to the image to be processed, so that the target effect image can be obtained. If the edge contour effect is the object contour effect, the object contour effect may be added to the target subject in the image to be processed, so that the target effect image is obtained. If the edge contour effect is the frame effect, the frame effect may be directly added to the image to be processed, and the processed image may be used as the target effect image.

Optionally, the adding the edge contour effect to the image to be processed to obtain a target effect image includes: fusing the image to be processed with the edge contour effect to obtain the target effect image.

After the edge contour effect is determined, the edge contour effect and the image to be processed may be fused, and the processed image may be displayed as the target effect image on a display interface. For example, when the edge contour effect is a rectangular frame flame effect, after the image to be processed and the edge contour effect are fused, a target effect image in which the image to be processed is located inside a rectangular frame and a frame edge presents a flame effect can be obtained. When the edge contour effect is an object contour flame effect corresponding to the target subject, after the image to be processed and the edge contour effect are fused, a target effect image in which an edge contour of the target subject in the image to be processed presents a flame effect can be obtained. The advantage of this setting is that the edge contour effect can be more attached to the image to be processed, and the display effect of the target effect image is further improved. For example, as shown in the figure, the edge contour effect may be a flame frame effect. The image to be processed is fused with the flame frame effect, so that the target effect image in which a border of the image to be processed is the flame effect can be obtained.

The edge contour effect is drawn by an effect developer with reference to a corresponding image in an application software development stage, and the effect display effect of the edge contour effect may be different from a real visual effect. Therefore, in this embodiment, to make the display effect of the edge contour effect closer to the real effect, the edge contour effect may be further processed, and then the processed edge contour effect may be added to the image to be processed, so that a more realistic target effect image can be obtained.

Before the adding the edge contour effect to the image to be processed to obtain a target effect image, the method further includes: if it is detected that there is a sequence frame material corresponding to the edge contour effect, superimposing the sequence frame material on the edge contour effect to update the edge contour effect.

In this embodiment, the sequence frame material may include a plurality of effect material frames, and each effect material frame corresponds to a static display effect of the edge contour effect. In practical applications, each effect material frame has a corresponding time stamp, and the effect material frames are spliced in a time sequence displayed according to the time stamps, to obtain the sequence frame material. For example, when the edge contour effect is a flame effect, a corresponding sequence frame material thereof may be a plurality of consecutive images determined based on a video of a flame burning state.

In an early development stage of an effect prop, when a plurality of edge contour effects are determined, a sequence frame material corresponding to each edge contour effect may be determined and stored correspondingly, so that when the edge contour effect corresponding to the image to be processed is determined, if there is a sequence frame material corresponding to the edge contour effect corresponding to the image to be processed in a plurality of pre-stored sequence frame materials, the sequence frame material may be directly retrieved and superimposed on the edge contour effect to update the edge contour effect. The advantage of this setting is that the effect display effect of the edge contour effect can be made closer to the real effect, and the reality of the edge contour effect is enhanced, thereby improving the display effect of the effect image.

According to the technical solution of the embodiments of the present disclosure, an image to be processed is acquired in response to an effect trigger operation, an edge contour effect corresponding to the image to be processed is determined, and the edge contour effect is added to the image to be processed to obtain a target effect image, thereby enriching effect props. When a user uses the effect props, edge contour effects of different styles may be determined, so that different target effect images may present different effect display effects, thereby improving the richness and interestingness of effect display images and improving the user experience.

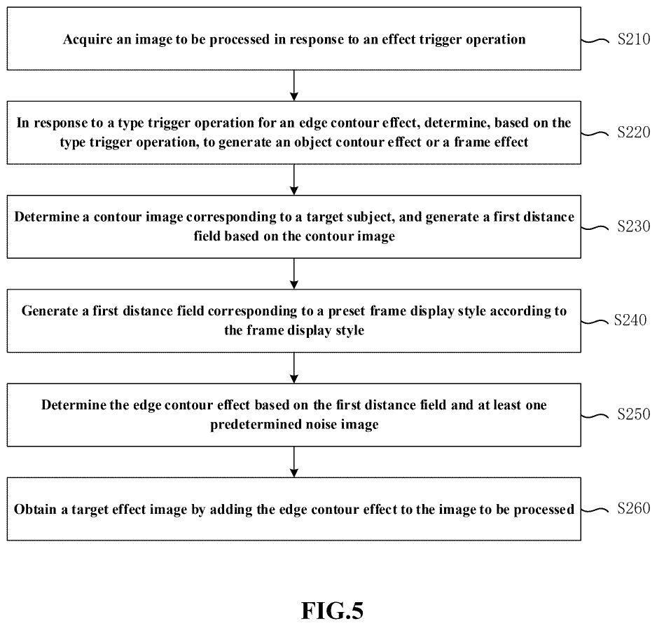

FIG. 5 is a schematic flowchart of an effect image generation method according to embodiments of the present disclosure. On the basis of the foregoing embodiment, it may be determined whether the generated edge contour effect is an object contour effect or a frame effect, so that a target effect image may be obtained based on the edge contour effect of different types respectively. For a specific implementation of the method, reference may be made to the technical solution of this embodiment. Technical terms the same as or corresponding to those in the foregoing embodiments are not described again herein.

As shown in FIG. 5, the method includes the following steps.

S210: Acquire an image to be processed in response to an effect trigger operation.

S220: In response to a type trigger operation for an edge contour effect, determining, based on the type trigger operation, to generate an object contour effect or a frame effect.

In this embodiment, a control for triggering an effect type may be pre-developed. When it is detected that the user triggers the control, a response may be made to the type trigger operation, thereby determining to generate the object contour effect or the frame effect. One implementation of the response to the type trigger operation may be as follows: after the image to be processed is obtained, a display list or a display control including the effect type of the edge contour effect may be displayed on a display interface, and when it is detected that the user triggers any effect type in the display list or the display control, a response may be made to the type trigger operation, thereby determining, based on the type trigger operation, whether to generate the object contour effect or the frame effect. Another implementation of the response to the type trigger operation may be as follows: after the image to be processed is obtained, it may be detected whether the image to be processed includes a target subject. When it is detected that the image to be processed includes the target subject, the application software may use an event of detecting the target subject as a trigger operation of the object contour effect. When it is detected that the image to be processed does not include the target subject, the event of not detecting the target subject may be used as a trigger operation of the frame effect. A person skilled in the art may understand that a specific event selected as a trigger condition of the effect type may be set based on actual situations, and is not specifically limited in the embodiments of the present disclosure. The advantage of this setting is that the richness and interestingness of the effect image content are improved, and the interactive effect with the user is enhanced to meet the personalized needs of the user.

When it is determined, based on the type trigger operation, to generate the object contour effect, step S230 may be performed; when it is determined, based on the type trigger operation, to generate the frame effect, step S240 may be performed.

S230: Determining a contour image corresponding to a target subject, and generating a first distance field based on the contour image.

In this embodiment, the contour image may be an image generated based on an outer contour line of the target subject. In practical applications, after the image to be processed including the target subject is obtained, contour line information of the target subject in the image to be processed may be extracted, and then the corresponding contour image may be determined based on the contour line information of the target subject. The contour image includes an overall contour displayed by the target subject in the image to be processed.

After the contour image corresponding to the target subject is determined, the contour displayed by the target subject in the image to be processed may be obtained, a distance between each pixel point in an inner region of the contour and the contour may be determined, and these distance values may be set to negative values. In addition, a distance between each pixel point in an outer region of the contour and the contour may be determined, and these distance values may be set to positive values. The contour may be used as a dividing line, and a first distance value and a second distance value may be selected in inner and outer regions of the contour respectively, so that a region constructed by at least one pixel point with a distance of the first distance value from the contour in the inner region of the contour and at least one pixel point with a distance of the second distance value from the contour in the outer region of the contour may be used as the first distance field. For example, the first distance value may be −0.5, the second distance value may be 1, at least one pixel point with a distance value of −0.5 is determined in the inner region of the contour, and at least one pixel point with a distance value of 1 is determined in the outer region of the contour, so that the first distance field may be generated based on these pixel points.

S240: Generating a first distance field corresponding to a frame display style according to a preset frame display style.

In this embodiment, there may be a plurality of frame display styles. Optionally, the frame display styles may include a square frame, a circular frame, a heart-shaped frame, a polygon frame, and the like.

In practical applications, after the image to be processed is obtained and it is determined that the edge contour effect is the frame effect, a display list including a plurality of frame display styles may be displayed on a display interface, a currently selected frame display style may be determined based on a user's trigger operation, and then the first distance field corresponding to the frame display style may be generated according to a frame contour corresponding to the frame display style and a preset range of distance values corresponding to each pixel point in inner and outer regions of the frame contour. The generation process of the first distance field corresponding to the frame display style is the same as that of the first distance field corresponding to the contour image, and this step will not be specifically described herein.

For example, with reference to FIG. 2, if the frame display style is a square frame, the first distance field corresponding to the frame display style may be a junction region between the black region and the white region.

S250: Determining the edge contour effect based on the first distance field and at least one predetermined noise image.

Whether the first distance field corresponding to the contour image or the first distance field corresponding to the frame display style is generated, the corresponding edge contour effect may be determined based on step S250.

In this embodiment, after the first distance field is determined, the at least one predetermined noise image may be retrieved, and then the edge contour effect may be determined based on the first distance field and the at least one noise image. In the process of generating the object contour effect and the frame effect with the same effect display effect, the same noise image is used, that is, the noise image may be matched with the effect display effect of the edge contour effect.

Optionally, the determining the edge contour effect based on the first distance field and at least one predetermined noise image includes: determining, based on the first distance field and a value noise image, a disturbed distance field of an edge disturbance; determining a noise image to be applied based on the disturbed distance field and preset fractal noise; and determining the edge contour effect based on the noise image to be applied and preset superimposition information.

In this embodiment, the value noise image may be used to represent a random offset corresponding to each pixel point in the first distance field, and then a pixel value of the corresponding pixel point after noise processing may be determined based on these offsets, and a distance field after processing may be determined based on these pixel values. The finally obtained distance field may be used as the disturbed distance field. A person skilled in the art may understand that the fractal noise may be formed by superimposing a plurality of Perlin noises with different parameters such as frequency, amplitude, and phase. Since the Perlin noise implements continuity through an interpolation method, and a result of adding continuous functions is still a continuous function, the fractal noise also has continuity. In addition, a change trend of the fractal noise needs to have obvious randomness, so that a frequent and violent fluctuation effect is visually presented, and this randomness is also enhanced by adding a plurality of different Perlin noises. The advantage of determining the edge contour effect based on the first distance field and the at least one predetermined noise image is that the display effect of the edge contour effect can be more realistic and more in line with the real display effect. At the same time, the diversity of the edge contour effect is improved, thereby improving the display effect of effect display images.

Both the value noise image and the fractal noise may be an image pre-stored in a storage space, or an image randomly generated in real time after the first distance field is determined. This is not specifically limited in the embodiments of the present disclosure.

In practical applications, after the first distance field is obtained, each pixel point in the first distance field may be processed based on the value noise image, so that the disturbed distance field may be finally obtained.

Optionally, the determining, based on the first distance field and a value noise image, a disturbed distance field of an edge disturbance includes: for each of at least one pixel point in the first distance field, obtaining a value noise corresponding to the pixel point in the value noise image, and determining a target pixel value of the pixel point based on the value noise and texture coordinates of the pixel point; and determining the disturbed distance field of the edge disturbance based on target pixel values of the at least one pixel point.

In this embodiment, for each pixel point in the first distance field, the pixel point may be mapped to the value noise image to determine an offset of the pixel point in the value noise image, and the offset may be used as the value noise of the pixel point. Texture coordinates of each pixel point may be determined by mapping the first distance field to a UV texture space. A person skilled in the art may understand that when UVs are used as two-dimensional texture coordinate points residing on vertices of a polygon mesh, a two-dimensional texture coordinate system is defined, and this coordinate system is the UV texture space. In this space, U and V are used to define coordinate axes for determining how to place a texture image on a two-dimensional image. In other words, the UVs provide a connection relationship between the two-dimensional image and the texture image, and are responsible for determining which pixel point on the two-dimensional image a pixel point on the texture image should be placed on, so that the entire texture can be paved on the two-dimensional image.

Based on this, it may be understood that the texture coordinates of each pixel point are UV coordinate values corresponding to the pixel point, and a range of the UV coordinate values may be between 0 and 1.

In practical applications, for each pixel point in the first distance field, the pixel point may be mapped to the value noise image to determine the value noise corresponding to the pixel point, and then the texture coordinates of the pixel point are determined, and the value noise and the texture coordinates are superimposed to obtain texture coordinates of the pixel point after offset. Then, a pixel value of the pixel point in the first distance field after offset may be determined, and the pixel value may be used as the target pixel value of the pixel point. After the target pixel value of each pixel point in the first distance field is determined, color information corresponding to the corresponding pixel point may be determined based on the target pixel value of each pixel point, so that the disturbed distance field of the edge disturbance may be finally determined. The advantage of this setting is that the target pixel value corresponding to each pixel point can be accurately determined, so that the disturbed distance field with a preset disturbance effect can be obtained, so that the corresponding edge contour effect can be determined based on the disturbed distance field.

For example, as shown in FIG. 2 and FIG. 6, when each pixel point in the first distance field shown in FIG. 2 is processed by value noise, a target pixel value corresponding to each pixel point may be obtained. Based on these target pixel values, color information of the corresponding pixel point may be determined, and may include black, gray, and white, so that the disturbed distance field shown in FIG. 6 may be finally obtained.

The determining a noise image to be applied based on the disturbed distance field and preset fractal noise includes: generating a second noise image based on the fractal noise and preset flow direction information; and determining the noise image to be applied from the second noise image by using the disturbed distance field as a mask.

The pixel value in the second noise image corresponds to the preset flow direction information. Content of the noise image to be applied corresponds to the preset flow direction information.

In this embodiment, the preset flow direction information may be preset information used to determine a dynamic flow direction of the edge contour effect. For example, when the edge contour effect is a flame effect, the preset flow direction information may be information determined based on a flame fluttering direction. The mask may be a separate layer used to block some image content and display image content of a specific region, and may be equivalent to a window.

In practical applications, unprocessed fractal noise may be acquired, and a plurality of parameters of the fractal noise may be adjusted based on a current effect requirement, for example, noise density and noise intensity may be adjusted to obtain the adjusted fractal noise. Time information may be added in a Y-axis direction of the fractal noise, and then a pixel value of each pixel point in the fractal noise at a plurality of time points may be determined according to the preset flow direction information, so that the second noise image may be generated based on these pixel values.

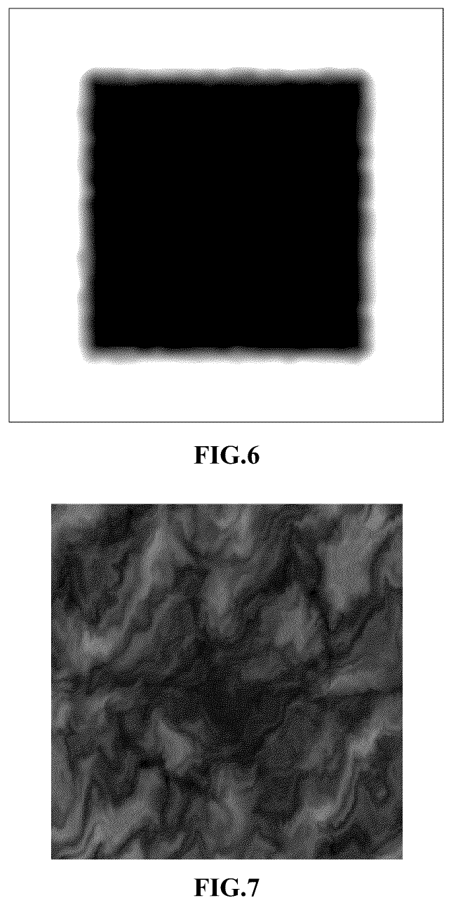

For example, as shown in FIG. 7. After the second noise image is obtained, the disturbed distance field may be used as a mask to cover the second noise image, and a distance value between each pixel point in the second noise image and a border of the disturbed distance field may be determined, and then each pixel point within the distance interval may be determined based on a preset distance interval. In this case, a ratio of a pixel value of each pixel point to the corresponding distance value of the pixel point may be determined, and the ratio is used as a target pixel value of the pixel point, so that the noise image to be applied may be determined based on these target pixel values. The advantage of this setting is that the flow effect of the edge contour effect is enhanced, so that the effect display effect of the edge contour effect is closer to the real effect, thereby improving the display effect of the effect image.

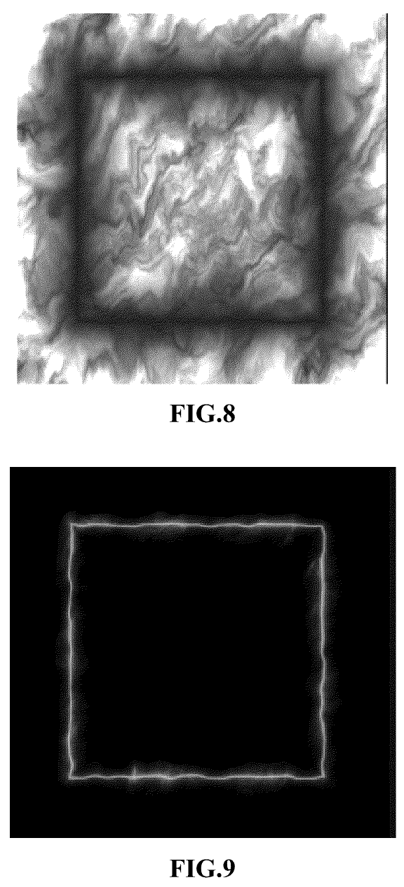

For example, as shown in FIG. 8, FIG. 8 may be a display diagram of an effect of superimposing the disturbed distance field on the second noise image. As shown in FIG. 9, FIG. 9 may be the noise image to be applied. Since a distance value of the border is 0, when a ratio of a pixel value of a pixel point to a distance value is determined, for each pixel point located on the border, a target pixel value obtained after the pixel value is divided by the corresponding distance value is a positive infinity value. Therefore, an image with a center boundary of the border and a brightness display changing from strong to weak may be obtained, that is, the border has the strongest brightness display, and the brightness display gradually weakens inward and outward.

Optionally, the determining the edge contour effect based on the noise image to be applied and preset superimposition information includes: determining the edge contour effect based on gray values of at least one pixel point in the noise image to be applied and the preset superimposition information.

In this embodiment, since the pixel value of each pixel point in the noise image to be applied is obtained after image intensity transformation, the pixel intensity value of each pixel point in the noise image to be applied may be used as the gray value. The superimposition information may include color information and pattern information.

In practical applications, after the noise image to be applied is obtained, the pixel intensity of each pixel point in the noise image to be applied may be determined to obtain the gray value of each pixel point in the noise image to be applied, and then the gray value of each pixel point is processed based on the preset superimposition information, so that the edge contour effect may be finally obtained. The advantage of this setting is that the effect display props are enriched, and the richness and interestingness of the picture content are improved, thereby improving the user experience.

When the superimposition information is the color information, a corresponding edge contour effect is determined differently from a corresponding edge contour effect when the superimposition information is the pattern information. The following describes the determination of these two edge contour effects respectively.

Optionally, when the superimposition information includes the color information, the color information includes a preset mapping between gray values and superimposed colors. The determining the edge contour effect based on gray values of at least one pixel point in the noise image to be applied and the preset superimposition information includes: determining a target color of each of at least one pixel point in the noise image to be applied according to the preset mapping between the gray values and the superimposed colors, to determine the edge contour effect based on the target color.

In this embodiment, a color conversion relationship between a plurality of gray values and a plurality of superimposed colors may be preset, and a plurality of color mapping tables may be generated. After the gray value of each pixel point in the noise image to be applied is determined and the superimposed color is determined, a color mapping table corresponding to the currently determined superimposed color may be acquired, and then a corresponding color conversion relationship may be determined in the color mapping table based on the gray value of each pixel point in the noise image to be applied. The gray value of the corresponding pixel point is processed based on the color conversion relationship, so that the target color corresponding to each pixel point may be obtained, and the edge contour effect may be determined based on the target color. The advantage of this setting is that the effect display props are enriched, and the richness and interestingness of the effect display content are improved, thereby improving the display effect of the effect image.

For example, after the gray value of each pixel point in the noise image to be applied is obtained and it is determined that the superimposed color is red, a ratio of the gray value of each pixel point to a pixel value corresponding to red may be determined, and color information corresponding to these ratios may be determined, to obtain the target color of the at least one pixel point in the noise image to be applied.

Optionally, when the superimposition information includes the pattern information, the determining the edge contour effect based on gray values of at least one pixel point in the noise image to be applied and the preset superimposition information includes: determining display brightness of the pattern information in the noise image to be applied based on the gray values of at least one pixel point in the noise image to be applied, to display the pattern information based on the display brightness, so as to obtain the edge contour effect.

In this embodiment, the pattern information may be information highly similar to an effect pattern corresponding to the edge contour effect. In practical applications, at least one pixel point may be determined in the noise image to be applied based on the pattern information, and then the gray value of each of the at least one pixel point may be determined, and these gray values may be used as a brightness value of each pixel point in the pattern information. The display brightness of the pattern information is determined based on the brightness value of each pixel point in the pattern information, and the pattern information is displayed based on the display brightness, so that the edge contour effect may be finally obtained. The advantage of this setting is that the effect display props are enriched, and the richness and interestingness of the effect display content are improved, thereby improving the display effect of the effect image.

Optionally, the edge contour effect includes an animation effect, and motion information of at least part of effects in the animation effect corresponds to the preset flow direction information.

In this embodiment, the animation effect may be an effect presenting a dynamic display effect. In practical applications, when the edge contour effect is an animation effect, motion information of some or all effects in the animation effect may be matched with the preset flow direction information, so that the dynamic display effect of the edge contour effect is more realistic and closer to the real effect. For example, when the edge contour effect is a flame animation effect, motion information of the flame animation effect may be matched with a preset flame rising direction, to obtain the edge contour effect in which the flame is in a burning state.

S260: Obtaining a target effect image by adding the edge contour effect to the image to be processed.

According to the technical solution of the embodiments of the present disclosure, an image to be processed is acquired in response to an effect trigger operation, and in response to a type trigger operation for an edge contour effect, it is determined, based on the type trigger operation, to generate an object contour effect or a frame effect. Further, a contour image corresponding to a target subject is determined, and a first distance field is generated based on the contour image, or a first distance field corresponding to a preset frame display style is generated according to the preset frame display style. Then, an edge contour effect is determined based on the first distance field and at least one predetermined noise image. Finally, the edge contour effect is added to the image to be processed to obtain a target effect image, thereby implementing an effect of obtaining target effect images with different display effects based on the edge contour effect of different types, which not only improves the richness and diversity of effect display images, but also enhances the interactive effect with the user.

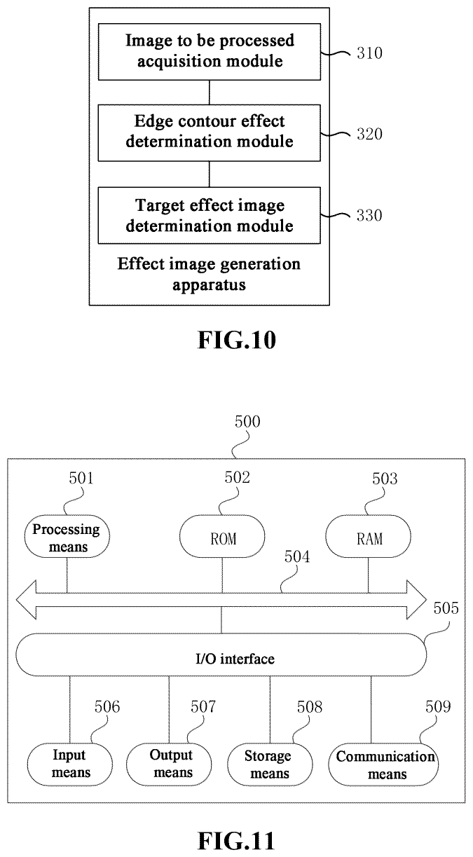

FIG. 10 is a schematic structural diagram of an effect image generation apparatus according to embodiments of the present disclosure. As shown in FIG. 10, the apparatus includes: an image to be processed acquisition module 310, an edge contour effect determination module 320, and a target effect image determination module 330.

The image to be processed acquisition module 310 is configured to acquire an image to be processed in response to an effect trigger operation; the edge contour effect determination module 320 is configured to determine an edge contour effect corresponding to the image to be processed; and the target effect image determination module 330 is configured to obtain a target effect image by adding the edge contour effect to the image to be processed, where the edge contour effect is obtained based on a distance field and at least one noise image.

On the basis of the foregoing technical solution, the edge contour effect comprises at least one of: an object contour effect corresponding to a target subject in the image to be processed, and a frame effect corresponding to the image to be processed.

On the basis of the foregoing technical solution, the apparatus further includes a type trigger operation response module.

The type trigger operation response module is configured to, before the determining an edge contour effect corresponding to the image to be processed, in response to a type trigger operation for an edge contour effect, determine, based on the type trigger operation, to generate an object contour effect or a frame effect.

On the basis of the foregoing technical solution, the edge contour effect determination module 320 includes a target subject determination submodule, an object contour effect generation submodule, and a frame effect generation submodule.

The target subject determination submodule is configured to determine whether the image to be processed comprises the target subject; the object contour effect generation submodule is configured to, in response to determining that the image to be processed comprises the target subject, generate the object contour effect based on the target subject; and the frame effect generation submodule is configured to, in response to determining that the image to be processed does not comprise the target subject, generate the frame effect based on the image to be processed ..

On the basis of the foregoing technical solution, the edge contour effect determination module 320 includes a contour image determination submodule or a first distance field generation submodule and an edge contour effect determination submodule.

The contour image determination submodule is configured to determine a contour image corresponding to a target subject in the image to be processed, and generate a first distance field based on the contour image; or the first distance field generation submodule is configured to generate a first distance field corresponding to a preset frame display style according to the preset frame display style; and the edge contour effect determination submodule is configured to determine the edge contour effect based on the first distance field and at least one predetermined noise image.

On the basis of the foregoing technical solution, the edge contour effect determination submodule includes a disturbed distance field determination unit, a noise image to be applied determination unit, and an edge contour effect determination unit.

The disturbed distance field determination unit is configured to determine a disturbed distance field of an edge disturbance based on the first distance field and a value noise image; the noise image to be applied determination unit is configured to determine a noise image to be applied based on the disturbed distance field and preset fractal noise; and the edge contour effect determination unit is configured to determine the edge contour effect based on the noise image to be applied and preset superimposition information.

On the basis of the foregoing technical solution, the disturbed distance field determination unit includes a target pixel value determination subunit and a disturbed distance field determination subunit.

The target pixel value determination subunit is configured to, for each of at least one pixel point in the first distance field, obtain a value noise corresponding to the pixel point in the value noise image, and determine a target pixel value of the pixel point based on the value noise and a texture coordinate of the pixel point; and the disturbed distance field determination subunit is configured to determine the disturbed distance field of the edge disturbance based on a target pixel value of the at least one pixel point.

On the basis of the foregoing technical solution, the noise image to be applied determination unit includes a second noise image determination subunit and a noise image to be applied determination subunit.

The second noise image determination subunit is configured to generate a second noise image based on the fractal noise and preset flow direction information, where a pixel value in the second noise image corresponds to the preset flow direction information; and the noise image to be applied determination subunit is configured to determine the noise image to be applied from the second noise image by using the disturbed distance field as a mask, where content of the noise image to be applied corresponds to the preset flow direction information.

On the basis of the foregoing technical solution, the edge contour effect determination unit includes an edge contour effect determination subunit.

The edge contour effect determination subunit is configured to determine the edge contour effect based on a gray value of at least one pixel point in the noise image to be applied and the preset superimposition information.

On the basis of the foregoing technical solution, the superimposition information includes color information, and the color information includes a preset mapping between a gray value and a superimposed color; and the edge contour effect determination subunit is configured to determine a target color of each of the at least one pixel point in the noise image to be applied according to the preset mapping between the gray value and the superimposed color, to determine the edge contour effect based on the target color.

On the basis of the foregoing technical solution, the superimposition information includes pattern information, and the edge contour effect determination subunit is configured to determine display brightness of the pattern information in the noise image to be applied based on the gray value of at least one pixel point in the noise image to be applied, to obtain the edge contour effect by displaying the pattern information based on the display brightness.

On the basis of the foregoing technical solution, the target effect image determination module 330 is configured to obtain the target effect image by fusing the image to be processed with the edge contour effect.

On the basis of the foregoing technical solution, the apparatus further includes a sequence frame material superimposition module.

The sequence frame material superimposition module is configured to, before the adding the edge contour effect to the image to be processed to obtain a target effect image, in response to detecting that a sequence frame material corresponding to the edge contour effect exists, update the edge contour effect by superimposing the sequence frame material on the edge contour effect.

On the basis of the foregoing technical solution, the edge contour effect includes an animation effect, and motion information of at least part of effects in the animation effect corresponds to the preset flow direction information.

According to the technical solution of the embodiments of the present disclosure, an image to be processed is acquired in response to an effect trigger operation, an edge contour effect corresponding to the image to be processed is determined, and the edge contour effect is added to the image to be processed to obtain a target effect image, thereby enriching effect props. When a user uses the effect props, edge contour effects of different styles may be determined, so that different target effect images may present different effect display effects, thereby improving the richness and interestingness of effect display images and improving the user experience.

The effect image generation apparatus provided in these embodiments of the present disclosure can perform the effect image generation method provided in any embodiment of the present disclosure, and has corresponding functional modules and effects for performing the method.

The plurality of units and modules included in the above apparatus are only divided according to functional logic, but are not limited to the above division, as long as corresponding functions can be implemented. In addition, names of the plurality of units and modules are only used to distinguish each other conveniently, and are not used to limit the scope of protection of the embodiments of the present disclosure.

FIG. 11 is a schematic structural diagram of an electronic device according to embodiments of the present disclosure. Referring to FIG. 11 below, it shows a schematic structural diagram of an electronic device (for example, a terminal device or a server in FIG. 11) 500 suitable for implementing the embodiments of the present disclosure. The terminal device in these embodiments of the present disclosure may include, but is not limited to, mobile terminals such as a mobile phone, a notebook computer, a digital broadcast receiver, a personal digital assistant (PDA), a tablet computer (PAD), a portable media player (PMP), and a vehicle-mounted terminal (such as a vehicle navigation terminal), and fixed terminals such as a digital television (TV) and a desktop computer. The electronic device shown in FIG. 11 is merely an example, and shall not impose any limitation on the function and scope of use of the embodiments of the present disclosure.

As shown in FIG. 11, the electronic device 500 may include a processing apparatus (for example, a central processor, a graphics processor, and the like) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to each other through a bus 504. An input/output (I/O) interface 505 is also connected to the bus 504.

Generally, the following apparatuses may be connected to the I/O interface 505: an input apparatus 506 including, for example, a touch screen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 11 shows the electronic device 500 having various apparatuses, it should be understood that it is not required to implement or have all of the shown apparatuses. It may be an alternative to implement or have more or fewer apparatuses.

According to embodiments of the present disclosure, the process described above with reference to the flowcharts may be implemented as a computer software program. For example, these embodiments of the present disclosure include a computer program product, which includes a computer program carried on a non-transitory computer-readable medium, where the computer program includes program code for performing the method shown in the flowchart. In such an embodiment, the computer program may be downloaded from a network through the communication apparatus 509 and installed, or installed from the storage apparatus 508, or installed from the ROM 502. When the computer program is executed by the processing apparatus 501, the above functions defined in the method of the embodiments of the present disclosure are performed.

Names of messages or information exchanged between a plurality of apparatuses in the implementation of the present disclosure are used for illustrative purposes only, and are not used to limit the scope of these messages or information.

The electronic device provided in these embodiments of the present disclosure and the effect image generation method provided in the above embodiments belong to the same inventive concept. For technical details not described in detail in this embodiment, reference may be made to the above embodiment, and these embodiments have the same effect as the above embodiment.

Embodiments of the present disclosure provide a computer storage medium having a computer program stored thereon, where when the program is executed by a processor, the effect image generation method provided in the above embodiments is implemented.

The above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. A more specific example of the computer-readable storage medium may include, but is not limited to: an electrical connection having one or more wires, a portable computer magnetic disk, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program that may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), and the like, or any suitable combination thereof.

In some implementations, the client and the server may communicate using any currently known or future-developed network protocol such as a HyperText Transfer Protocol (HTTP), and may be connected to digital data communication (for example, a communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: acquire an image to be processed in response to an effect trigger operation; determine an edge contour effect corresponding to the image to be processed; and add the edge contour effect to the image to be processed to obtain a target effect image, where the edge contour effect is obtained based on a distance field and at least one noise image.

The computer program code for performing the operations of the present disclosure may be written in one or more programming languages or a combination thereof, where the programming languages include but are not limited to an object-oriented programming language, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of a remote computer, the remote computer may be connected to the computer of the user through any type of network, including a local area network (LAN) or a wide area network (WAN), or may be connected to an external computer (for example, connected through the Internet using an Internet service provider).

The flowcharts and block diagrams in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that in some alternative implementations, the functions marked in the blocks may also occur in an order different from that marked in the accompanying drawings. For example, two blocks shown in succession can actually be executed substantially in parallel, or they can sometimes be executed in the reverse order, depending on the functions involved. It should also be noted that each block of the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The units and modules involved in the description of the embodiments of the present disclosure may be implemented by means of software, or may be implemented by means of hardware. The names of the units and modules do not constitute a limitation on the units and modules themselves in some cases. For example, the image to be processed acquisition module may also be described as “a module that acquires an image to be processed in response to an effect trigger operation”.

The functions described hereinabove in the context of the present disclosure may be performed at least partially by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include but is not limited to electronic, magnetic, optical, electromagnetic, infrared, or semiconductor systems, apparatuses, or devices, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination thereof.

According to one or more embodiments of the present disclosure, [Example 1] provides an effect image generation method, where the method includes: acquiring an image to be processed in response to an effect trigger operation; determining an edge contour effect corresponding to the image to be processed; and obtaining a target effect image by adding the edge contour effect to the image to be processed, where the edge contour effect is obtained based on a distance field and at least one noise image.

According to one or more embodiments of the present disclosure, [Example 2] provides an effect image generation method. Optionally, the edge contour effect comprises at least one of: an object contour effect corresponding to a target subject in the image to be processed, and a frame effect corresponding to the image to be processed.

According to one or more embodiments of the present disclosure, [Example 3] provides an effect image generation method. The method further includes: optionally, in response to a type trigger operation for an edge contour effect, determining, based on the type trigger operation, to generate an object contour effect or a frame effect.

According to one or more embodiments of the present disclosure, [Example 4] provides an effect image generation method. Optionally, the determining an edge contour effect corresponding to the image to be processed includes: determining whether the image to be processed comprises the target subject; in response to determining that the image to be processed comprises the target subject, generating the object contour effect based on the target subject; and in response to determining that the image to be processed does not comprise the target subject, generating the frame effect based on the image to be processed.

According to one or more embodiments of the present disclosure, [Example 5] provides an effect image generation method. Optionally, the determining an edge contour effect corresponding to the image to be processed includes: determining a contour image corresponding to a target subject in the image to be processed, and generating a first distance field based on the contour image; or generating a first distance field corresponding to a preset frame display style according to the preset frame display style; and determining the edge contour effect based on the first distance field and at least one predetermined noise image.

According to one or more embodiments of the present disclosure, [Example 6] provides an effect image generation method. Optionally, the determining the edge contour effect based on the first distance field and at least one predetermined noise image includes: determining a disturbed distance field of an edge disturbance based on the first distance field and a value noise image; determining a noise image to be applied based on the disturbed distance field and preset fractal noise; and determining the edge contour effect based on the noise image to be applied and preset superimposition information.

According to one or more embodiments of the present disclosure, [Example 7] provides an effect image generation method. Optionally, the determining, based on the first distance field and the value noise image, a disturbed distance field of an edge disturbance includes: for each of at least one pixel point in the first distance field, obtaining a value noise corresponding to the pixel point in the value noise image, and determining a target pixel value of the pixel point based on the value noise and a texture coordinate of the pixel point; and determining the disturbed distance field of the edge disturbance based on a target pixel value of the at least one pixel point.

According to one or more embodiments of the present disclosure, [Example 8] provides an effect image generation method. Optionally, the determining a noise image to be applied based on the disturbed distance field and preset fractal noise includes: generating a second noise image based on the fractal noise and preset flow direction information, where a pixel value in the second noise image corresponds to the preset flow direction information; and determining the noise image to be applied from the second noise image by using the disturbed distance field as a mask, where content of the noise image to be applied corresponds to the preset flow direction information.

According to one or more embodiments of the present disclosure, [Example 9] provides an effect image generation method. Optionally, the determining the edge contour effect based on the noise image to be applied and preset superimposition information includes: determining the edge contour effect based on a gray value of at least one pixel point in the noise image to be applied and the preset superimposition information.

According to one or more embodiments of the present disclosure, [Example 10] provides an effect image generation method. Optionally, the superimposition information includes color information, and the color information includes a preset mapping between gray values and superimposed colors; and the determining the edge contour effect based on gray values of at least one pixel point in the noise image to be applied and the preset superimposition information includes: determining a target color of each of the at least one pixel point in the noise image to be applied according to the preset mapping between the gray value and the superimposed color, to determine the edge contour effect based on the target color.

According to one or more embodiments of the present disclosure, [Example 11] provides an effect image generation method. Optionally, the superimposition information includes pattern information; and the determining the edge contour effect based on gray values of at least one pixel point in the noise image to be applied and the preset superimposition information includes: determining display brightness of the pattern information in the noise image to be applied based on the gray value of at least one pixel point in the noise image to be applied, to obtain the edge contour effect by displaying the pattern information based on the display brightness.

According to one or more embodiments of the present disclosure, [Example 12] provides an effect image generation method. Optionally, the adding the edge contour effect to the image to be processed to obtain a target effect image includes: obtaining the target effect image by fusing the image to be processed with the edge contour effect.

According to one or more embodiments of the present disclosure, [Example 13] provides an effect image generation method. The method further includes: optionally, in response to detecting that a sequence frame material corresponding to the edge contour effect exists, updating the edge contour effect by superimposing the sequence frame material on the edge contour effect.

According to one or more embodiments of the present disclosure, [Example 14] provides an effect image generation method. Optionally, the edge contour effect includes an animation effect, and motion information of at least part of the animation effect corresponds to a preset flow direction information.

According to one or more embodiments of the present disclosure, [Example 15] provides an effect image generation apparatus, where the apparatus includes: an image to be processed acquisition module, configured to acquire an image to be processed in response to an effect trigger operation; an edge contour effect determination module, configured to determine an edge contour effect corresponding to the image to be processed; and a target effect image determination module, configured to obtain a target effect image by adding the edge contour effect to the image to be processed, where the edge contour effect is obtained based on a distance field and at least one noise image.

Although various operations are depicted in a specific order, it should be understood as requiring these operations to be performed in the specific order shown or in a sequential order. Under certain circumstances, multitasking and parallel processing may be advantageous. Similarly, although specific implementation details are included in the foregoing discussions, these details should not be construed as limiting the scope of the present disclosure. Some features that are described in the context of separate embodiments can also be implemented in combination in a single embodiment. A plurality of features described in the context of a single embodiment can also be implemented in a plurality of embodiments individually or in any suitable sub-combination.

Although the subject matter has been described in a language specific to structural features and/or methodological logical actions, it should be understood that the subject matter defined in the appended claims is not necessarily limited to the specific features or actions described above. The specific features and actions described above are merely exemplary forms of implementing the claims.

1. An effect image generation method, comprising:
acquiring an image to be processed in response to an effect trigger operation;
determining an edge contour effect corresponding to the image to be processed; and
obtaining a target effect image by adding the edge contour effect to the image to be processed,
wherein the edge contour effect is obtained based on a distance field and at least one noise image.

2. The method according to claim 1, wherein the edge contour effect comprises at least one of: an object contour effect corresponding to a target subject in the image to be processed, and a frame effect corresponding to the image to be processed.

3. The method according to claim 1, wherein the method further comprises, before determining the edge contour effect corresponding to the image to be processed:
in response to a type trigger operation for an edge contour effect, determining, based on the type trigger operation, to generate an object contour effect or a frame effect.

4. The method according to claim 2, wherein determining the edge contour effect corresponding to the image to be processed comprises:
determining whether the image to be processed comprises the target subject;
in response to determining that the image to be processed comprises the target subject, generating the object contour effect based on the target subject; and
in response to determining that the image to be processed does not comprise the target subject, generating the frame effect based on the image to be processed.

5. The method according to claim 2, wherein determining the edge contour effect corresponding to the image to be processed comprises:
determining a contour image corresponding to a target subject in the image to be processed, and generating a first distance field based on the contour image; or generating a first distance field corresponding to a preset frame display style according to the preset frame display style; and
determining the edge contour effect based on the first distance field and at least one predetermined noise image.

6. The method according to claim 5, wherein determining the edge contour effect based on the first distance field and the at least one predetermined noise image comprises:
determining a disturbed distance field of an edge disturbance based on the first distance field and a value noise image;
determining a noise image to be applied based on the disturbed distance field and preset fractal noise; and
determining the edge contour effect based on the noise image to be applied and preset superimposition information.

7. The method according to claim 6, wherein determining the disturbed distance field of the edge disturbance based on the first distance field and the value noise image comprises:
for each of at least one pixel point in the first distance field, obtaining a value noise corresponding to the pixel point in the value noise image, and determining a target pixel value of the pixel point based on the value noise and a texture coordinate of the pixel point; and
determining the disturbed distance field of the edge disturbance based on a target pixel value of the at least one pixel point.

8. The method according to claim 6, wherein determining the noise image to be applied based on the disturbed distance field and the preset fractal noise comprises:
generating a second noise image based on the fractal noise and preset flow direction information, wherein a pixel value in the second noise image corresponds to the preset flow direction information; and
determining the noise image to be applied from the second noise image by using the disturbed distance field as a mask,
wherein content of the noise image to be applied corresponds to the preset flow direction information.

9. The method according to claim 6, wherein determining the edge contour effect based on the noise image to be applied and the preset superimposition information comprises:
determining the edge contour effect based on a gray value of at least one pixel point in the noise image to be applied and the preset superimposition information.

10. The method according to claim 9, wherein the superimposition information comprises color information, and the color information comprises a preset mapping between a gray value and a superimposed color; and
determining the edge contour effect based on the gray value of at least one pixel point in the noise image to be applied and the preset superimposition information comprises:
determining a target color of each of the at least one pixel point in the noise image to be applied according to the preset mapping between the gray value and the superimposed color, to determine the edge contour effect based on the target color.

11. The method according to claim 9, wherein the superimposition information comprises pattern information; and
determining the edge contour effect based on the gray value of at least one pixel point in the noise image to be applied and the preset superimposition information comprises:
determining display brightness of the pattern information in the noise image to be applied based on the gray value of at least one pixel point in the noise image to be applied, to obtain the edge contour effect by displaying the pattern information based on the display brightness.

12. The method according to claim 1, wherein obtaining the target effect image by adding the edge contour effect to the image to be processed comprises:
obtaining the target effect image by fusing the image to be processed with the edge contour effect.

13. The method according to claim 1, wherein the method further comprises, before obtaining the target effect image by adding the edge contour effect to the image to be processed:
in response to detecting that a sequence frame material corresponding to the edge contour effect exists, updating the edge contour effect by superimposing the sequence frame material on the edge contour effect.

14. The method according to claim 1, wherein the edge contour effect comprises an animation effect, and motion information of at least part of the animation effect corresponds to a preset flow direction information.

15. (canceled)

16. An electronic device, comprising:
at least one processor; and
a storage, configured to store at least one program,
wherein the at least one program, when executed by the at least one processor, causes the at least one processor to:
acquire an image to be processed in response to an effect trigger operation;
determine an edge contour effect corresponding to the image to be processed; and
obtain a target effect image by adding the edge contour effect to the image to be processed,
wherein the edge contour effect is obtained based on a distance field and at least one noise image.

17. A non-transitory storage medium comprising computer-executable instructions, wherein the computer-executable instructions, when executed by a computer processor, causing a computer to:
acquire an image to be processed in response to an effect trigger operation;
determine an edge contour effect corresponding to the image to be processed; and
obtain a target effect image by adding the edge contour effect to the image to be processed,
wherein the edge contour effect is obtained based on a distance field and at least one noise image.

18. The device according to claim 16, wherein the edge contour effect comprises at least one of: an object contour effect corresponding to a target subject in the image to be processed, and a frame effect corresponding to the image to be processed.

19. The device according to claim 16, wherein the at least one program further causes the at least one processor to, before determining the edge contour effect corresponding to the image to be processed:
in response to a type trigger operation for an edge contour effect, determine, based on the type trigger operation, to generate an object contour effect or a frame effect.

20. The device according to claim 17, wherein the at least one program causing the at least one processor to determine the edge contour effect corresponding to the image to be processed further causes the at least one processor to:
determine whether the image to be processed comprises the target subject;
in response to determining that the image to be processed comprises the target subject, generate the object contour effect based on the target subject; and
in response to determining that the image to be processed does not comprise the target subject, generate the frame effect based on the image to be processed.

21. The device according to claim 17, wherein the at least on program causing the at least one processor to determine the edge contour effect corresponding to the image to be processed further cause the at least one processor to:
determine a contour image corresponding to a target subject in the image to be processed, and generating a first distance field based on the contour image; or generating a first distance field corresponding to a preset frame display style according to the preset frame display style; and
determine the edge contour effect based on the first distance field and at least one predetermined noise image.
